(19) United States
(12) Patent Application Publication
(10) Pub. No.: US 2024/0319724 A1
(43) Pub. Date: Sep. 26, 2024

(54) SYSTEMS AND METHODS FOR MONITORING A PLURALITY OF VEHICLES BY TELEOPERATOR

(71) Applicant: Toyota Connected North America, Inc., Plano, TX (US)

(72) Inventors: Imad Zahid, Carrollton, TX (US); Shravanthi Denthumdas, Frisco, TX (US); Mark Anthony McClung, Celina, TX (US)

(73) Assignee: Toyota Connected North America, Inc., Plano, TX (US)

(21) Appl. No.: 18/124,780

(22) Filed: Mar. 22, 2023

(51) Int. Cl. G05D 1/00; G06N 3/006; G07C 5/00

(52) U.S. Cl. CPC G05D 1/0016; G06N 3/006; G07C 5/008

(57) ABSTRACT

Systems and methods for monitoring a plurality of vehicles by a teleoperator are provided. The systems include a controller programmed to: obtain state information about a plurality of physical vehicles, generate a plurality of virtual vehicles linked to the plurality of physical vehicles based on the state information about the plurality of physical vehicles, determine driving values for the plurality of virtual vehicles based on the state information, initiate teleoperations on one or more virtual vehicles based on the driving values, and control one or more physical vehicles linked to the one or more virtual vehicles in response to receiving inputs on the one or more virtual vehicles.

### TECHNICAL FIELD

The present disclosure relates to systems and methods for monitoring a plurality of vehicles by a teleoperator.

### BACKGROUND

Accurately controlling a plurality of vehicles may be desired for many reasons. Conventional systems and methods for controlling a vehicle may control a single physical vehicle by a teleoperator. However, the teleoperator may not monitor a plurality of physical vehicles simultaneously. When the teleoperator monitors a plurality of physical vehicles, the teleoperator may not accurately monitor physical vehicles because the views of physical vehicles provided to the teloperator are limited.

Accordingly, a need exists for systems and methods that accurately monitor a plurality of vehicles by a teleoperator.

### SUMMARY

The present disclosure provides systems and methods for monitoring a plurality of vehicles by a teleoperator. The systems and methods accurately monitor a plurality of vehicles by the teleoperator by initiating teleoperations and controlling one or more physical vehicles linked to the one or more virtual vehicles based on driving values. With the accurate monitoring of the plurality of physical vehicles, the vehicles may have an efficient motion system, such as acceleration, lane-change, and avoid undesired situations.

In one or more embodiments, a system of monitoring a plurality of vehicles by a teleoperator includes a controller. The controller is programmed to obtain state information about a plurality of physical vehicles, generate a plurality of virtual vehicles linked to the plurality of physical vehicles based on the state information about the plurality of physical vehicles, determine driving values for the plurality of virtual vehicles based on the state information, initiate teleoperations on one or more virtual vehicles based on the driving values, and control one or more physical vehicles linked to the one or more virtual vehicles in response to receiving inputs on the one or more virtual vehicles.

In another embodiment, a method of monitoring a plurality of vehicles by a teleoperator includes obtaining state information about a plurality of physical vehicles, generating a plurality of virtual vehicles linked to the plurality of physical vehicles based on the state information about the plurality of physical vehicles, determining driving values for the plurality of virtual vehicles based on the state information, initiating teleoperations on one or more virtual vehicles based on the driving values, and controlling one or more physical vehicles linked to the one or more virtual vehicles in response to receiving inputs on the one or more virtual vehicles.

These and additional features provided by the embodiments of the present disclosure will be more fully understood in view of the following detailed description, in conjunction with the drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIGS. 1A-1D depict exemplary systems of monitoring a plurality of vehicles by a teleoperator, according to one or more embodiments shown and described herein;

FIG. 2 depicts a schematic diagram of systems of monitoring a plurality of vehicles by a teleoperator, according to one or more embodiments shown and described herein; and

FIG. 3 depicts a flowchart for methods of monitoring a plurality of vehicles by a teleoperator, according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

The embodiments disclosed herein include systems and methods for monitoring a plurality of vehicles by a teleoperator. The systems and methods accurately monitor a plurality of vehicles by the teleoperator by obtaining state information about a plurality of physical vehicles, generating a plurality of virtual vehicles linked to the plurality of physical vehicles based on the state information about the plurality of physical vehicles, determining driving values for the plurality of virtual vehicles based on the state information, initiating teleoperations on one or more virtual vehicles based on the driving values, and controlling one or more physical vehicles linked to the one or more virtual vehicles in response to receiving inputs on the one or more virtual vehicles. With the accurate monitoring of the plurality of physical vehicles, the vehicles may have an efficient motion system, such as acceleration, lane-change, and avoid undesired situations.

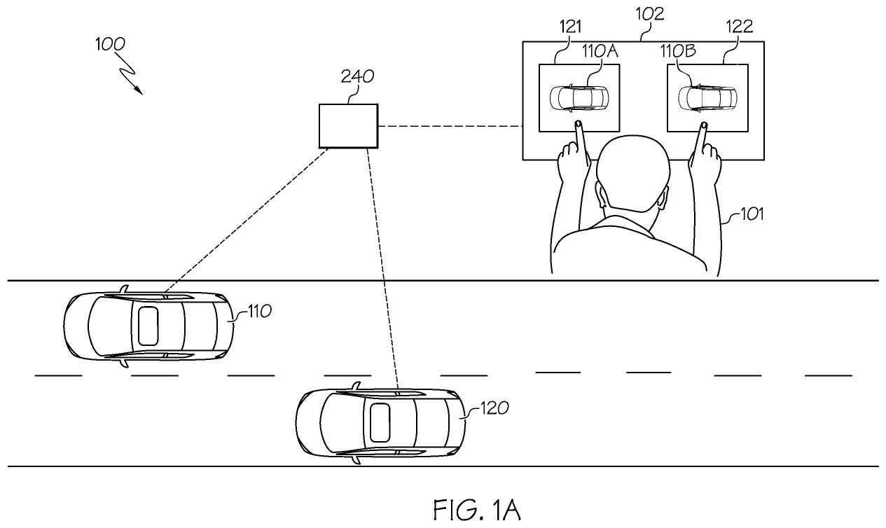

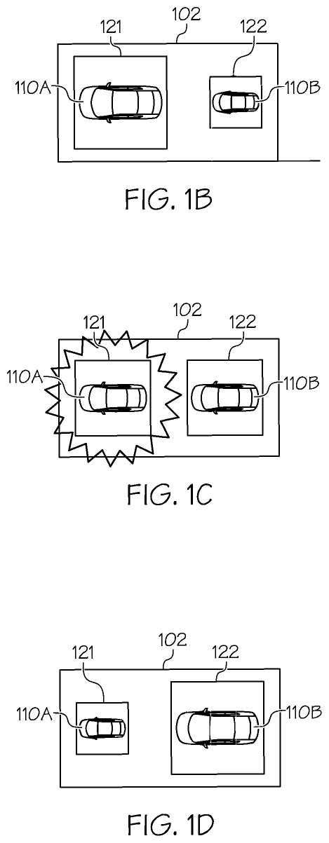

FIGS. 1A-1D depict exemplary systems of monitoring a plurality of vehicles by a teleoperator, according to one or more embodiments shown and described herein.

Referring to FIG. 1A, the system 100 of monitoring a plurality of vehicles by a teleoperator 101 includes a plurality of physical vehicles. The plurality of physical vehicles may include a first physical vehicle 110 and a second physical vehicle 120.

The first physical vehicle 110, the second physical vehicle 120, or both may be a vehicle including an automobile or any other passenger or non-passenger vehicle such as, for example, a terrestrial, aquatic, and/or airborne vehicle. In some embodiments, the first physical vehicle 110, the second physical vehicle 120, or both may be an autonomous driving vehicle. The first physical vehicle 110, the second physical vehicle 120, or both may be an autonomous vehicle that navigates its environment with limited human input or without human input. The first physical vehicle 110, the second physical vehicle 120, or both may be equipped with internet access and share data with other devices both inside and outside the first physical vehicle 110, the second physical vehicle 120, or both. The first physical vehicle 110, the second physical vehicle 120, or both may communicate with the server 240, and transmit their data to the server 240. For example, the first physical vehicle 110, the second physical vehicle 120, or both transmits information about their current location and destination, their environment, information about a current driver, information about a task that it is currently implementing, and the like. The first physical vehicle 110, the second physical vehicle 120, or both may include an actuator configured to move the first physical vehicle 110, the second physical vehicle 120, or both.

The system 100 may obtain state information about a plurality of physical vehicles. In embodiments, the state information may comprise colors of the plurality of physical vehicles, fuel gauges of the plurality of physical vehicles, models of the plurality of physical vehicles, types of the plurality of physical vehicles, movements of the plurality of physical vehicles, drivers of the plurality of physical vehicles, locations of the plurality of physical vehicles, status of drivers of the plurality of physical vehicles, status of passengers of the plurality of physical vehicles, contexts of driving situation of the plurality of physical vehicles, or combinations thereof. In embodiments, the state information may be gathered by one or more sensors of each of the plurality of physical vehicles. In embodiments, the state information may be gathered by one or more sensors, such as cameras, of each of the first physical vehicle 110 and the second physical vehicle 120.

The system 100 may generate a plurality of virtual vehicles linked to the plurality of physical vehicles based on the state information about the plurality of physical vehicles. In embodiments, the plurality of virtual vehicles may be linked to the plurality of physical vehicles based on the state information of the plurality of physical vehicles through a server 240, such as a cloud server. The system 100 may generate a plurality of virtual vehicles including the information linked to state information about the plurality of physical vehicles. The system 100 may display the information about the virtual vehicles linked to the state information about the physical vehicles on a screen 102.

For example, the system 100 may generate a first virtual vehicle 110A linked to the first physical vehicle 110. The system 100 may generate a second virtual vehicle 110B linked to the second physical vehicle 120. In embodiments, the system 100 may display the information about the first virtual vehicle 110A linked to the state information of the first physical vehicle 110 on the screen 102. In embodiments, the system 100 may display the information about the second virtual vehicle 110B linked to the state information of the second physical vehicle 120 on the screen 102. While FIG. 1A depicts two physical vehicles and two virtual vehicles, the system 100 may have more than two physical vehicles and two virtual vehicles.

The system 100 may determine driving values for the plurality of virtual vehicles based on the state information. The system 100 may initiate teleoperations on one or more virtual vehicles based on the driving values. The one or more virtual vehicles may be controlled in a photoreal metaverse environment by the teleoperator 101. For example, the system displays a front view of the vehicle 110 or the vehicle 120 linked to the virtual vehicle 110A or 110B on the screen 102, and the teleoperator 101 may remotely control the vehicle 110 or the vehicle 120 by operating on a steering wheel, an accelerator pedal, and/or a brake pedal in front of the teleoperator 101. Any other user interface may be provided for the teleoperator 101 to remotely control the vehicle 110 or 120. In embodiments, the system 100 may compare each of the driving values for the plurality of virtual vehicles to a threshold value. The system 100 may initiate teleoperations on the one or more virtual vehicles in response to the driving values for the one or more virtual vehicles being greater than the threshold value. In embodiments, the teleoperations may be initiated on two or more virtual vehicles.

For example, when the state information comprises colors of the plurality of physical vehicles, the system 100 may initiate teleoperations on virtual vehicles linked to physical vehicles having specific colors, such as yellow, red, or blue. For example, when the state information comprises fuel gauges of the plurality of physical vehicles, the system 100 may initiate teleoperations on virtual vehicles linked to physical vehicles having at least half of fuel gauges. For example, when the fuel gauge of a physical vehicle is less than a threshold amount, e.g., 0.2 gallon, the system 100 may initiate teleoperations on the virtual vehicle linked to the physical vehicle such that the teleoperator 101 may remotely control the physical vehicle to the closest gas station or electricity charging station. For example, when the state information comprises models of the plurality of physical vehicles, the system 100 may initiate teleoperations on virtual vehicles linked to physical vehicles made by specific manufactures. For example, when the state information comprises types of the plurality of physical vehicles, the system 100 may initiate teleoperations on virtual vehicles linked to physical vehicles, which are SUV models. For example, when the state information comprises movements of the plurality of physical vehicles, the system 100 may initiate teleoperations on virtual vehicles linked to physical vehicles moving to a specific direction, such as moving from north to south. For example, when the state information comprises drivers of the plurality of physical vehicles, the system 100 may initiate teleoperations on virtual vehicles linked to physical vehicles driven by drivers, who are older than specific ages, such as 50 years old. For example, when the state information comprises locations of the plurality of physical vehicles, the system 100 may initiate teleoperations on virtual vehicles linked to physical vehicles near a specific location. When the plurality of physical vehicles are on the highway, the system 100 may initiate teleoperations on virtual vehicles linked to physical vehicles near off-ramp of a highway. When the plurality of physical vehicles are near the highway, the system 100 may initiate teleoperations on virtual vehicles linked to physical vehicles near on-ramp of a highway. For example, when the state information comprises status of drivers of the plurality of physical vehicles, the system 100 may initiate teleoperations on virtual vehicles linked to physical vehicles driven by drivers more than or equal to specific hours, such as 2 hours. For example, when the state information comprises status of passengers of the plurality of physical vehicles, the system 100 may initiate teleoperations on virtual vehicles linked to physical vehicles having passengers in the physical vehicles more than or equal to specific hours, such as 2 hours. For example, when the state information comprises contexts of driving situation of the plurality of physical vehicles, the system 100 may initiate teleoperations on virtual vehicles linked to physical vehicles moving an opposite direction compare to vehicles close to physical vehicles.

In embodiments, the driving value for each of the plurality of virtual vehicles may comprise a speed, an acceleration, an orientation, or a yaw rate of corresponding physical vehicle. When the driving value for each of the plurality of virtual vehicles comprises a speed, an acceleration, an orientation, or a yaw rate of corresponding physical vehicle, the system 100 may determine whether a speed, an acceleration, an orientation, or a yaw rate of corresponding physical vehicle is greater than a threshold. The system 100 may initiate teleoperations on virtual vehicles linked to physical vehicles having a speed, an acceleration, an orientation, or a yaw rate greater than a threshold. For example, the threshold is a maximum speed limit on the road that the physical vehicles are driving. If the speed of a physical vehicle is greater than the current speed limit by a certain amount, for example, by 20 mph, the system 100 may initiate teleoperations on the virtual vehicle linked to the corresponding vehicle to decrease the speed of the corresponding vehicle. As another example, the threshold is a minimum speed limit on the road that the physical vehicles are vehicle. If the speed of a physical vehicle is less than the minimum speed limit by a certain amount, for example, by 10 mph, the system 100 may initiate teleoperations on the virtual vehicle linked to the corresponding vehicle to increase the speed of corresponding vehicle. As another example, the threshold may be an average speed of vehicles within a certain distance of a physical vehicle, e.g., within 0.1 mile. If the speed of the physical vehicle deviates from the average speed by a certain amount, e.g., 20 mph, the system 100 may initiate teleoperations on the virtual vehicle linked to the corresponding vehicle to adjust the speed of the corresponding vehicle.

In embodiments, the driving value for each of the plurality of virtual vehicles may comprise an amount of a deviation of corresponding vehicle from a center of a road. When the driving value for each of the plurality of virtual vehicles comprises an amount of a deviation of corresponding vehicle from a center of a road, the system 100 may determine whether the amount of the deviation of corresponding vehicle is greater than a threshold. The system 100 may initiate teleoperations on virtual vehicles linked to physical vehicles having the amount of the deviation greater than a threshold.

In embodiments, the driving value for each of the plurality of virtual vehicles may comprise an emergent need or urgent need of the teleoperations. For example, the system 100 may determine whether the passenger, the driver, or both of the physical vehicles need for an emergent care, urgent care, or both. The system 100 may initiate teleoperations on virtual vehicles linked to physical vehicles, where the passenger, the driver, or both of the physical vehicles need for an emergent care, urgent care, or both.

The system 100 may rank the plurality of virtual vehicles based on a rank queue system. The system 100 may rank the plurality of virtual vehicles based on a rank queue system using the driving value. For example, when the driving value for each of the plurality of virtual vehicles comprises an emergent need, an urgent need, or both, of the teleoperations, the system 100 may rank the plurality of virtual vehicles based on a rank queue system using the emergent need, the urgent need, or both. For example, when a passenger of the first physical vehicle 110 have an emergent need, an urgent need, or both, such as a surgery, and a passenger of the second physical vehicle 120 does not have the emergent need, the urgent need, or both, the system 100 may determine that the rank of the first physical vehicle 110 is higher than the rank of the second physical vehicle 120. The system 100 may initiate teleoperations on the virtual vehicle having a first rank first, such as the first physical vehicle 110 when a passenger of the first physical vehicle 110 have an emergent need, an urgent need, or both, and then initiate teleoperations on the virtual vehicle having a second rank, such as the second physical vehicle 120 when a passenger of the second physical vehicle 120 does not have the emergent need, the urgent need, or both. The first rank is higher than the second rank. The first rank has higher priority than the second rank.

In some embodiments, the system 100 may further include the screen 102. The screen 102 may be a screen of a display device of the teleoperator 101. The display device may include a navigation device, a smartphone, a smartwatch, a laptop, a tablet computer, a personal computer, a wearable device, or combinations thereof.

In embodiments, the system 100 may obtain views of the plurality of physical vehicles captured by sensors, such as cameras, of the plurality of physical vehicles. For example, the system 100 may obtain views of the first physical vehicle 110 captured by cameras of the first physical vehicle 110. For example, the system 100 may obtain views of the second physical vehicle 120 captured by cameras of the second physical vehicle 120.

The system 100 may generate virtual views linked to views of the plurality of physical vehicles. For example, the system 100 may generate a virtual view 121 linked to the view of the first physical vehicle 110. For example, the system 100 may generate a virtual view 122 linked to the view of the second physical vehicle 120.

The system 100 may display, on the screen 102, the virtual view linked to views of the plurality of physical vehicles. For example, the system 100 may display, on the screen 102, the virtual view 121 linked to the view of the first physical vehicle 110 and the virtual view 122 linked to the view of the second physical vehicle 120. In embodiments, the system 100 may display, on the screen 102, the virtual views linked to the views of one or more physical vehicles linked to the one or more virtual vehicles upon initiation of the teleoperations on the one or more virtual vehicles. For example, the system 100 may display, on the screen 102, the virtual view 121 linked to the view of first physical vehicle 110 linked to the first virtual vehicle 110A upon initiation of the teleoperations on the first virtual vehicle 110A. For example, the system 100 may display, on the screen 102, the virtual view 122 linked to the view of second physical vehicle 120 linked to the second virtual vehicle 110B upon initiation of the teleoperations on the second virtual vehicle 110B.

The system 100 may emphasize, on the screen 102, the virtual views linked to the views of one or more physical vehicles linked to the one or more virtual vehicles upon initiation of the teleoperations on the one or more virtual vehicles. For example, the system 100 may enlarge the virtual view linked to the view of one or more physical vehicles. The system 100 may enlarge at least one of the virtual view linked to the view of one or more physical vehicles. For example, referring to FIG. 1B, the system 100 may enlarge the virtual view 121 linked to the view of first physical vehicle 110 and may not enlarge the virtual view 122 linked to the view of the second physical vehicle 120. For example, the system 100 may blink the virtual view linked to the view of one or more physical vehicles such that the teleoperator 101 begins teleoperating the one or more physical vehicles. The system 100 may blink at least one of the virtual view linked to the view of one or more physical vehicles. For example, referring to FIG. 1B, the system 100 may blink the virtual view 121 linked to the view of first physical vehicle 110 and may not blink the virtual view 122 linked to the view of the second physical vehicle 120. For example, the system 100 may dwindle the virtual view linked to the view of one or more physical vehicles. The system 100 may dwindle at least one of the virtual view linked to the view of one or more physical vehicles. For example, referring to FIG. 1D, the system 100 may not dwindle the virtual view 121 linked to the view of first physical vehicle 110 and may dwindle the virtual view 122 linked to the view of the second physical vehicle 120.

Referring back to FIG. 1A, the system 100 may receive inputs on the one or more virtual vehicles by a teleoperator 101. The system 100 may control one or more physical vehicles linked to the one or more virtual vehicles in response to receiving inputs on the one or more virtual vehicles. For example, the teleoperator 101 may move the one or more virtual vehicles in the virtual views on the screen 102. The one or more physical vehicles linked to the one or more vehicles may be moved in response to receiving inputs, movement of the one or more vehicles on the screen. For example, the teleoperator 101 may move the one or more virtual vehicles on the screen 102 to make a left turn. The one or more physical vehicles linked to the one or more vehicles may be controlled to make a left turn in response to receiving inputs, a left turn movement of the one or more vehicles on the screen. For example, the teleoperator 101 may move the one or more virtual vehicles on the screen 102 to make a right turn. The one or more physical vehicles linked to the one or more vehicles may be controlled to make a right turn in response to receiving inputs, a right turn movement of the one or more vehicles on the screen. For example, the teleoperator 101 may move the one or more virtual vehicles forward on the screen 102. The one or more physical vehicles linked to the one or more vehicles may be controlled to move forward in response to receiving inputs, a movement of the one or more vehicles on the screen. For example, the teleoperator 101 may move the one or more virtual vehicles backward on the screen 102. The one or more physical vehicles linked to the one or more vehicles may be controlled to move backward in response to receiving inputs, a movement of the one or more vehicles on the screen. In embodiments, the teleoperator 101 may control other functions of one or more physical vehicles such as adjusting speed or accelerations, turning on/off headlights, turning on/off wipers, opening or closing windows/doors, locking windows/doors, and the like.

When the plurality of physical vehicles include the first physical vehicle 110 and the second physical vehicle 120, the teleoperator 101 may control the first virtual vehicle 110A linked to the first physical vehicle 110 and the second virtual vehicle 110B linked to the second physical vehicle 120. The teleoperator 101 may control the first virtual vehicle 110A on the virtual view 121 and the second virtual vehicle 110B on the virtual view 122. In embodiments, the teleoperator 101 may control the first virtual vehicle 110A and the second virtual vehicle 110B to make a same movement. In response to receiving inputs from the teleoperator 101, the first physical vehicle 110 and the second physical vehicle 120 may be controlled to make a same movement. For example, the teleoperator 101 may control the first virtual vehicle 110A and the second virtual vehicle 110B to make a left turn. In response to receiving inputs from the teleoperator 101, the first physical vehicle 110 and the second physical vehicle 120 may be controlled to make a left turn. For example, the teleoperator 101 may control the first virtual vehicle 110A and the second virtual vehicle 110B to make a right turn. In response to receiving inputs from the teleoperator 101, the first physical vehicle 110 and the second physical vehicle 120 may be controlled to make a right turn. For example, the teleoperator 101 may control the first virtual vehicle 110A and the second virtual vehicle 110B to move forward. In response to receiving inputs from the teleoperator 101, the first physical vehicle 110 and the second physical vehicle 120 may be controlled to move forward. For example, the teleoperator 101 may control the first virtual vehicle 110A and the second virtual vehicle 110B to move backward. In response to receiving inputs from the teleoperator 101, the first physical vehicle 110 and the second physical vehicle 120 may be controlled to move backward.

In embodiments, the teleoperator 101 may control the first virtual vehicle 110A and the second virtual vehicle 110B to make different movements. In response to receiving inputs from the teleoperator 101, the first physical vehicle 110 and the second vehicle may be controlled to make different movements. For example, the teleoperator 101 may control the first virtual vehicle 110A to move and control the second virtual vehicle 110B to stop. In response to receiving inputs from the teleoperator 101, the first physical vehicle 110 may be controlled to move and the second physical vehicle 120 may be controlled to stop. For example, the teleoperator 101 may control the first virtual vehicle 110A and the second virtual vehicle 110B to move different directions. In response to receiving inputs from the teleoperator 101, the first physical vehicle 110 and the second physical vehicle 120 may be controlled to move different directions. For example, the teleoperator 101 may control the first virtual vehicle 110A to move forward and the second virtual vehicle 110B to move backward. In response to receiving inputs from the teleoperator 101, the first physical vehicle 110 may be controlled to move forward and the second physical vehicle 120 may be controlled to move backward.

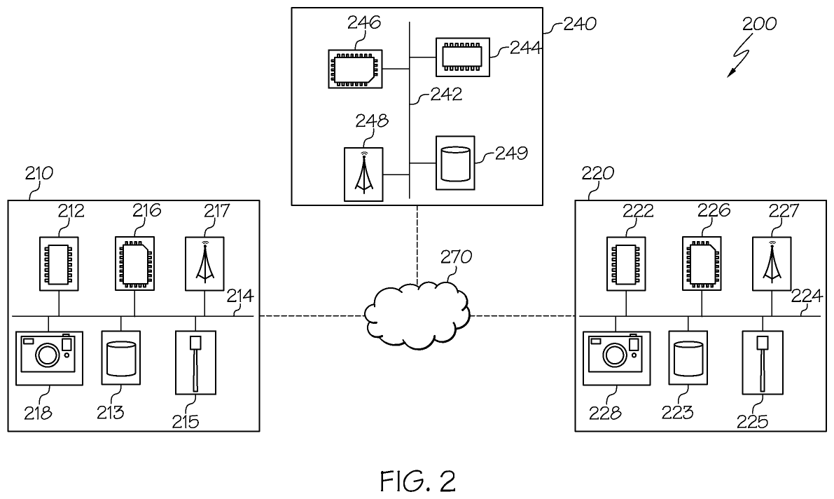

FIG. 2 depicts a schematic diagram of systems of monitoring a plurality of vehicles by a teleoperator, according to one or more embodiments shown and described herein.

Referring to FIG. 2, the system 200 includes a first physical vehicle system 210, and the server 240. In some embodiments, the system 200 may further include a second physical vehicle system 220.

The first physical vehicle system 210 includes one or more processors 212. Each of the one or more processors 212 may be any device capable of executing machine-readable and executable instructions. Each of the one or more processors 212 may be a controller, an integrated circuit, a microchip, a computer, or any other computing device. One or more processors 212 are coupled to a communication path 214 that provides signal interconnectivity between various modules of the system. The communication path 214 may communicatively couple any number of processors 212 with one another, and allow the modules coupled to the communication path 214 to operate in a distributed computing environment. Each of the modules may operate as a node that may send and/or receive data. As used herein, the term “communicatively coupled” means that coupled components are capable of exchanging data signals with one another such as electrical signals via a conductive medium, electromagnetic signals via air, optical signals via optical waveguides, and the like.

The communication path 214 may be formed from any medium that is capable of transmitting a signal such as conductive wires, conductive traces, optical waveguides, or the like. In some embodiments, the communication path 214 may facilitate the transmission of wireless signals, such as WiFi, Bluetooth®, Near Field Communication (NFC), and the like. The communication path 214 may be formed from a combination of mediums capable of transmitting signals. In one embodiment, the communication path 214 comprises a combination of conductive traces, conductive wires, connectors, and buses that cooperate to permit the transmission of electrical data signals to components such as processors, memories, sensors, input devices, output devices, and communication devices. The communication path 214 may comprise a vehicle bus, such as a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The first physical vehicle system 210 includes one or more memory modules 216 coupled to the communication path 214 and may contain non-transitory computer-readable medium comprising RAM, ROM, flash memories, hard drives, or any device capable of storing machine-readable and executable instructions such that the machine-readable and executable instructions can be accessed by the one or more processors 212. The machine-readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored in the one or more memory modules 216. The machine-readable and executable instructions may be written in a hardware description language (HDL), such as logic implemented via either a field-programmable gate array (FPGA) configuration or an application-specific integrated circuit (ASIC), or their equivalents. The methods described herein may be implemented in any conventional computer programming language, as pre-programmed hardware elements, or as a combination of hardware and software components. The one or more processors 212 along with the one or more memory modules 216 may operate as a controller for the first physical vehicle system 210.

Still referring to FIG. 2, the first physical vehicle system 210 includes one or more sensors 218. One or more sensors 218 may be any device having an array of sensing devices capable of detecting radiation in an ultraviolet wavelength band, a visible light wavelength band, or an infrared wavelength band. One or more sensors 218 may detect the presence of the first physical vehicle system 210, the presence of the second physical vehicle system 220, the distance between the first physical vehicle system 210 and the second physical vehicle system 220. One or more sensors 218 may have any resolution. In some embodiments, one or more optical components, such as a mirror, fish-eye lens, or any other type of lens may be optically coupled to one or more sensors 218. In some embodiments, one or more sensors 218 may provide image data to one or more processors 212 or another component communicatively coupled to the communication path 214. In some embodiments, one or more sensors 218 may provide navigation support. In embodiments, data captured by one or more sensors 218 may be used to autonomously or semi-autonomously navigate the first physical vehicle system 210.

In some embodiments, one or more sensors 218 include one or more imaging sensors configured to operate in the visual and/or infrared spectrum to sense visual and/or infrared light. In some embodiments, one or more sensors 218 include one or more LIDAR sensors, radar sensors, sonar sensors, or other types of sensors for gathering data that could be integrated into or supplement the data collection. Ranging sensors like radar sensors may be used to obtain rough depth and speed information for the view of the first physical vehicle system 210.

The first physical vehicle system 210 includes a satellite antenna 215 coupled to the communication path 214 such that the communication path 214 communicatively couples the satellite antenna 215 to other modules of the first physical vehicle system 210. The satellite antenna 215 is configured to receive signals from global positioning system satellites. In one embodiment, the satellite antenna 215 includes one or more conductive elements that interact with electromagnetic signals transmitted by global positioning system satellites. The received signal is transformed into a data signal indicative of the location (e.g., latitude and longitude) of the satellite antenna 215 or an object positioned near the satellite antenna 215, by one or more processors 212.

The first physical vehicle system 210 includes one or more vehicle sensors 213. Each of one or more vehicle sensors 213 is coupled to the communication path 214 and communicatively coupled to one or more processors 212. One or more vehicle sensors 213 may include one or more motion sensors for detecting and measuring motion and changes in the motion of the first physical vehicle system 210. The motion sensors may include inertial measurement units. Each of the one or more motion sensors may include one or more accelerometers and one or more gyroscopes. Each of one or more motion sensors transforms sensed physical movement of the vehicle into a signal indicative of an orientation, a rotation, a velocity, or an acceleration of the vehicle.

Still referring to FIG. 2, the first physical vehicle system 210 includes a network interface hardware 217 for communicatively coupling the first physical vehicle system 210 to the server 240. The network interface hardware 217 may be communicatively coupled to the communication path 214 and may be any device capable of transmitting and/or receiving data via a network. The network interface hardware 217 may include a communication transceiver for sending and/or receiving any wired or wireless communication. For example, the network interface hardware 217 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 217 includes hardware configured to operate in accordance with the Bluetooth® wireless communication protocol. The network interface hardware 217 of the first physical vehicle system 210 may transmit its data to the server 240. For example, the network interface hardware 217 of the first physical vehicle system 210 may transmit vehicle data, location data, maneuver data, and the like to the server 240.

The first physical vehicle system 210 may connect with one or more external vehicle systems (e.g., the second physical vehicle system 220) and/or external processing devices (e.g., a cloud server, or an edge server) via a direct connection. The direct connection may be a vehicle-to-vehicle connection (“V2V connection”), a vehicle-to-everything connection (“V2X connection”), or an mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mmWave) between the vehicles or between a vehicle and an infrastructure.

Vehicles may function as infrastructure nodes to form a mesh network and connect dynamically on an ad-hoc basis. In this way, vehicles may enter and/or leave the network at will, such that the mesh network may self-organize and self-modify over time. The network may include vehicles forming peer-to-peer networks with other vehicles or utilizing centralized networks that rely upon certain vehicles and/or infrastructure elements. The network may include networks using the centralized server and other central computing devices to store and/or relay information between vehicles.

Still referring to FIG. 2, the first physical vehicle system 210 may be communicatively coupled to the second physical vehicle system 220, the server 240, or both, by the network 270. In one embodiment, the network 270 may include one or more computer networks (e.g., a personal area network, a local area network, or a wide area network), cellular networks, satellite networks and/or a global positioning system and combinations thereof. The first physical vehicle system 210 may be communicatively coupled to the network 270 via a wide area network, a local area network, a personal area network, a cellular network, a satellite network, etc. Suitable local area networks may include wired Ethernet and/or wireless technologies such as Wi-Fi. Suitable personal area networks may include wireless technologies such as IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the second physical vehicle system 220 includes one or more processors 222, one or more memory modules 226, one or more sensors 228, one or more vehicle sensors 223, a satellite antenna 225, a network interface hardware 227, and a communication path 224 communicatively connected to the other components of second physical vehicle system 220. The components of the second physical vehicle system 220 may be structurally similar to and have similar functions as the corresponding components of the first physical vehicle system 210 (e.g., the one or more processors 222 corresponds to the one or more processors 212, the one or more memory modules 226 corresponds to the one or more memory modules 216, the one or more sensors 228 corresponds to the one or more sensors 218, the satellite antenna 225 corresponds to the satellite antenna 215, the communication path 224 corresponds to the communication path 214, and the network interface hardware 227 corresponds to the network interface hardware 217).

Still referring to FIG. 2, the server 240 includes one or more processors 244, one or more memory modules 246, a network interface hardware 248, one or more vehicle sensors 249, and a communication path 242 communicatively connected to the other components of the first physical vehicle system 210. The components of the server 240 may be structurally similar to and have similar functions as the corresponding components of the first physical vehicle system 210 (e.g., the one or more processors 244 corresponds to the one or more processors 212, the one or more memory modules 246 corresponds to the one or more memory modules 216, the one or more vehicle sensors 249 corresponds to the one or more vehicle sensors 213, the communication path 242 corresponds to the communication path 214, and the network interface hardware 248 corresponds to the network interface hardware 217).

It should be understood that the components illustrated in FIG. 2 are merely illustrative and are not intended to limit the scope of this disclosure. More specifically, while the components in FIG. 2 are illustrated as residing within the first physical vehicle system 210, this is a non-limiting example. In some embodiments, one or more of the components may reside external to the first physical vehicle system 210, the second physical vehicle system 220, or both, such as with the server 240.

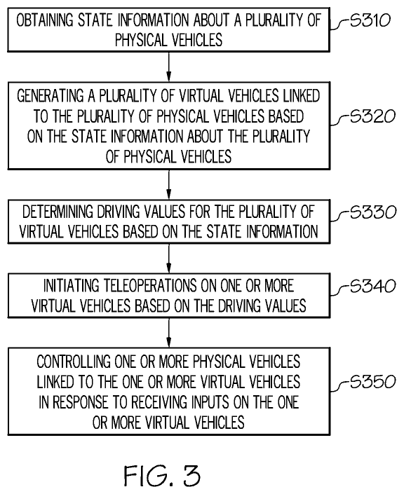

FIG. 3 depicts a flowchart for methods of monitoring a plurality of vehicles by a teleoperator that may be performed by the systems of FIGS. 1A-1D, according to one or more embodiments shown and described herein.

Referring to FIGS. 1A and 3, in step S310, a controller, e.g., the controller of a server 240, may obtain state information about a plurality of physical vehicles. In embodiments, the state information may comprise colors of the plurality of physical vehicles, fuel gauges of the plurality of physical vehicles, models of the plurality of physical vehicles, types of the plurality of physical vehicles, movements of the plurality of physical vehicles, drivers of the plurality of physical vehicles, locations of the plurality of physical vehicles, status of drivers of the plurality of physical vehicles, status of passengers of the plurality of physical vehicles, contexts of driving situation of the plurality of physical vehicles, or combinations thereof. In embodiments, the state information may be gathered by one or more sensors of each of the plurality of physical vehicles.

Referring to FIGS. 1A and 3, in step S320, the controller may generate a plurality of virtual vehicles linked to the plurality of physical vehicles based on the state information about the plurality of physical vehicles. The controller may generate a plurality of virtual vehicles including the information linked to state information about the plurality of physical vehicles. The controller may display the information about the virtual vehicles linked to the state information about the physical vehicles on a screen. For example, referring to FIG. 1A, the controller may generate a first virtual vehicle 110A linked to the first physical vehicle 110. The controller may generate a second virtual vehicle 110B linked to the second physical vehicle 120. In embodiments, the controller may display the information about the first virtual vehicle 110A linked to the state information of the first physical vehicle 110 on the screen. In embodiments, the controller may display the information about the second virtual vehicle 110B linked to the state information of the second physical vehicle 120 on the screen 102.

Referring to FIGS. 1A and 3, in step S330, the controller may determine driving values for the plurality of virtual vehicles based on the state information. In embodiments, the controller may compare each of the driving values for the plurality of virtual vehicles to a threshold value.

Referring to FIGS. 1A and 3, in step S340, the controller may initiate teleoperations on one or more virtual vehicles based on the driving values. The controller may initiate teleoperations on the one or more virtual vehicles in response to the driving values for the one or more virtual vehicles being greater than the threshold value. In embodiments, the teleoperations may be initiated on two or more virtual vehicles. The one or more virtual vehicles may be controlled in a photoreal metaverse environment.

For example, when the state information comprises colors of the plurality of physical vehicles, the controller may initiate teleoperations on virtual vehicles linked to physical vehicles having specific colors, such as yellow, red, or blue. For example, when the state information comprises fuel gauges of the plurality of physical vehicles, the controller may initiate teleoperations on virtual vehicles linked to physical vehicles having at least half of fuel gauges. For example, when the fuel gauge of a physical vehicle is less than a threshold amount, e.g., 0.2 gallon, the controller may initiate teleoperations on the virtual vehicle linked to the physical vehicle such that the teleoperator 101 may remotely control the physical vehicle to the closest gas station or electricity charging station. For example, when the state information comprises models of the plurality of physical vehicles, the controller may initiate teleoperations on virtual vehicles linked to physical vehicles made by specific manufactures. For example, when the state information comprises types of the plurality of physical vehicles, the controller may initiate teleoperations on virtual vehicles linked to physical vehicles, which are SUV models. For example, when the state information comprises movements of the plurality of physical vehicles, the controller may initiate teleoperations on virtual vehicles linked to physical vehicles moving to a specific direction, such as moving from north to south. For example, when the state information comprises drivers of the plurality of physical vehicles, the controller may initiate teleoperations on virtual vehicles linked to physical vehicles driven by drivers, who are older than specific ages, such as 50 years old. For example, when the state information comprises locations of the plurality of physical vehicles, the controller may initiate teleoperations on virtual vehicles linked to physical vehicles near a specific location. When the plurality of physical vehicles are on the highway, the controller may initiate teleoperations on virtual vehicles linked to physical vehicles near off-ramp of a highway. When the plurality of physical vehicles are near the highway, the controller may initiate teleoperations on virtual vehicles linked to physical vehicles near on-ramp of a highway. For example, when the state information comprises status of drivers of the plurality of physical vehicles, the controller may initiate teleoperations on virtual vehicles linked to physical vehicles driven by drivers more than or equal to specific hours, such as 2 hours. For example, when the state information comprises status of passengers of the plurality of physical vehicles, the controller may initiate teleoperations on virtual vehicles linked to physical vehicles having passengers in the physical vehicles more than or equal to specific hours, such as 2 hours. For example, when the state information comprises contexts of driving situation of the plurality of physical vehicles, the controller may initiate teleoperations on virtual vehicles linked to physical vehicles moving an opposite direction compare to vehicles close to physical vehicles.

In embodiments, the driving value for each of the plurality of virtual vehicles may comprise a speed, an acceleration, an orientation, or a yaw rate of corresponding physical vehicle. When the driving value for each of the plurality of virtual vehicles comprises a speed, an acceleration, an orientation, or a yaw rate of corresponding physical vehicle, the controller may determine whether a speed, an acceleration, an orientation, or a yaw rate of corresponding physical vehicle is greater than a threshold. The controller may initiate teleoperations on virtual vehicles linked to physical vehicles having a speed, an acceleration, an orientation, or a yaw rate greater than a threshold. For example, the threshold is a maximum speed limit on the road that the physical vehicles are driving. If the speed of a physical vehicle is greater than the current speed limit by a certain amount, for example, by 20 mph, the controller may initiate teleoperations on the virtual vehicle linked to the corresponding vehicle to decrease the speed of the corresponding vehicle. As another example, the threshold is a minimum speed limit on the road that the physical vehicles are vehicle. If the speed of a physical vehicle is less than the minimum speed limit by a certain amount, for example, by 10 mph, the controller may initiate teleoperations on the virtual vehicle linked to the corresponding vehicle to increase the speed of corresponding vehicle. As another example, the threshold may be an average speed of vehicles within a certain distance of a physical vehicle, e.g., within 0.1 mile. If the speed of the physical vehicle deviates from the average speed by a certain amount, e.g., 20 mph, the controller may initiate teleoperations on the virtual vehicle linked to the corresponding vehicle to adjust the speed of the corresponding vehicle.

In embodiments, the driving value for each of the plurality of virtual vehicles may comprise an amount of a deviation of corresponding vehicle from a center of a road. When the driving value for each of the plurality of virtual vehicles comprises an amount of a deviation of corresponding vehicle from a center of a road, the controller may determine whether the amount of the deviation of corresponding vehicle is greater than a threshold. The controller may initiate teleoperations on virtual vehicles linked to physical vehicles having the amount of the deviation greater than a threshold.

In embodiments, the driving value for each of the plurality of virtual vehicles may comprise an emergent need or urgent need of the teleoperations. For example, the controller may determine whether the passenger, the driver, or both of the physical vehicles need for an emergent care, urgent care, or both. The controller may initiate teleoperations on virtual vehicles linked to physical vehicles, where the passenger, the driver, or both of the physical vehicles need for an emergent care, urgent care, or both.

The controller may rank the plurality of virtual vehicles based on a rank queue system. The controller may rank the plurality of virtual vehicles based on a rank queue system using the driving value. For example, when the driving value for each of the plurality of virtual vehicles comprises an emergent need, an urgent need, or both, of the teleoperations, the controller may rank the plurality of virtual vehicles based on a rank queue system using the emergent need, the urgent need, or both. For example, when a passenger of the first physical vehicle 110 have an emergent need, an urgent need, or both, such as a surgery, and a passenger of the second physical vehicle 120 does not have the emergent need, the urgent need, or both, the controller may determine that the rank of the first physical vehicle 110 is higher than the rank of the second physical vehicle 120. The controller may initiate teleoperations on the virtual vehicle having a first rank first, such as the first physical vehicle 110 when a passenger of the first physical vehicle 110 have an emergent need, an urgent need, or both, and then initiate teleoperations on the virtual vehicle having a second rank, such as the second physical vehicle 120 when a passenger of the second physical vehicle 120 does not have the emergent need, the urgent need, or both. The first rank is higher than the second rank. The first rank has higher priority than the second rank.

In embodiments, the controller may obtain views of the plurality of physical vehicles. The controller may generate virtual views linked to views of the plurality of physical vehicles.

In embodiments, the controller may display, on the screen 102, the virtual views linked to the views of the plurality of physical vehicles. For example, the controller may display, on the screen 102, the virtual view 121 linked to the view of the first physical vehicle 110 and the virtual view 122 linked to the view of the second physical vehicle 120.

In embodiments, the controller may emphasize, on the screen 102, the virtual views linked to the views of one or more physical vehicles linked to the one or more virtual vehicles upon initiation of the teleoperations on the one or more virtual vehicles. For example, the controller may enlarge the virtual view linked to the view of one or more physical vehicles. The controller may enlarge at least one of the virtual view linked to the view of one or more physical vehicles. For example, referring to FIG. 1B, the controller may enlarge the virtual view 121 linked to the view of first physical vehicle 110 and may not enlarge the virtual view 122 linked to the view of the second physical vehicle 120. For example, the controller may blink the virtual view linked to the view of one or more physical vehicles. The controller may blink at least one of the virtual view linked to the view of one or more physical vehicles. For example, referring to FIG. 1B, the controller may blink the virtual view 121 linked to the view of first physical vehicle 110 and may not blink the virtual view 122 linked to the view of the second physical vehicle 120. For example, the controller may dwindle the virtual view linked to the view of one or more physical vehicles. The controller may dwindle at least one of the virtual view linked to the view of one or more physical vehicles. For example, referring to FIG. 1D, the controller may not dwindle the virtual view 121 linked to the view of first physical vehicle 110 and may dwindle the virtual view 122 linked to the view of the second physical vehicle 120.

Referring back to FIGS. 1A and 3, in step S350, the controller may control one or more physical vehicles linked to the one or more virtual vehicles in response to receiving inputs on the one or more virtual vehicles. For example, when the plurality of physical vehicles include the first physical vehicle 110 and the second physical vehicle 120, the teleoperator 101 may control a first virtual vehicle 110A linked to the first physical vehicle 110 and a second virtual vehicle 110B linked to the second physical vehicle 120. The teleoperator 101 may control the first virtual vehicle 110A on the virtual view 121 and the second virtual vehicle 110B on the virtual view 122. In embodiments, the teleoperator 101 may control the first virtual vehicle 110A and the second virtual vehicle 110B to make a same movement. For example, the teleoperator 101 may control the first virtual vehicle 110A and the second virtual vehicle 110B to make a left turn. In response to receiving inputs from the teleoperator 101, the first physical vehicle 110 and the second physical vehicle 120 may be controlled to make a left turn. For example, the teleoperator 101 may control the first virtual vehicle 110A and the second virtual vehicle 110B to make a right turn. In response to receiving inputs from the teleoperator 101, the first physical vehicle 110 and the second physical vehicle 120 may be controlled to make a right turn. For example, the teleoperator 101 may control the first virtual vehicle 110A and the second virtual vehicle 110B to move forward. In response to receiving inputs from the teleoperator 101, the first physical vehicle 110 and the second physical vehicle 120 may be controlled to move forward. For example, the teleoperator 101 may control the first virtual vehicle 110A and the second virtual vehicle 110B to move backward. In response to receiving inputs from the teleoperator 101, the first physical vehicle 110 and the second physical vehicle 120 may be controlled to move backward.

In embodiments, the teleoperator 101 may control the first virtual vehicle 110A and the second virtual vehicle 110B to make different movements. In response to receiving inputs from the teleoperator 101, the first physical vehicle 110 and the second vehicle may be controlled to make different movements. For example, the teleoperator 101 may control the first virtual vehicle 110A to move and control the second virtual vehicle 110B to stop. In response to receiving inputs from the teleoperator 101, the first physical vehicle 110 may be controlled to move and the second physical vehicle 120 may be controlled to stop. For example, the teleoperator 101 may control the first virtual vehicle 110A and the second virtual vehicle 110B to move different directions. In response to receiving inputs from the teleoperator 101, the first physical vehicle 110 and the second physical vehicle 120 may be controlled to move different directions. For example, the teleoperator 101 may control the first virtual vehicle 110A to move forward and the second virtual vehicle 110B to move backward. In response to receiving inputs from the teleoperator 101, the first physical vehicle 110 may be controlled to move forward and the second physical vehicle 120 may be controlled to move backward.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A system comprising:
a controller programmed to:
obtain state information about a plurality of physical vehicles;
generate a plurality of virtual vehicles linked to the plurality of physical vehicles based on the state information about the plurality of physical vehicles;
determine driving values for the plurality of virtual vehicles based on the state information;
initiate teleoperations on one or more virtual vehicles based on the driving values; and
control one or more physical vehicles linked to the one or more virtual vehicles in response to receiving inputs on the one or more virtual vehicles.

2. The system according to claim 1, wherein the one or more virtual vehicles is controlled in a photoreal metaverse environment.

3. The system according to claim 1, wherein the teleoperations are initiated on two or more virtual vehicles.

4. The system according to claim 1, wherein the controller is further programmed to:
link the plurality of virtual vehicles to the plurality of physical vehicles based on the state information of the plurality of physical vehicles through a cloud server.

5. The system according to claim 1, wherein the controller is further programmed to:
compare each of the driving values for the plurality of virtual vehicles to a threshold value; and
initiate teleoperations on the one or more virtual vehicles in response to the driving values for the one or more virtual vehicles being greater than the threshold value.

6. The system according to claim 1, wherein the controller is further programmed to:
rank the plurality of virtual vehicles based on a rank queue system;
initiate teleoperations on the virtual vehicle having a first rank first and then initiate teleoperations on the virtual vehicle having a second rank, wherein the first rank is higher than the second rank.

7. The system according to claim 1, wherein the driving value for each of the plurality of virtual vehicles comprises an emergent need, an urgent need, or both, of the teleoperations.

8. The system according to claim 1, wherein the state information comprises colors of the plurality of physical vehicles, fuel gauges of the plurality of physical vehicles, models of the plurality of physical vehicles, types of the plurality of physical vehicles, movements of the plurality of physical vehicles, drivers of the plurality of physical vehicles, locations of the plurality of physical vehicles, status of drivers of the plurality of physical vehicles, status of passengers of the plurality of physical vehicles, contexts of driving situation of the plurality of physical vehicles, or combinations thereof.

9. The system according to claim 1, wherein the state information is gathered by one or more sensors of each of the plurality of physical vehicles.

10. The system according to claim 1, wherein the driving value for each of the plurality of virtual vehicles comprises an amount of a deviation of corresponding vehicle from a center of a road, and the controller is further programmed to:
determine whether the amount of the deviation of corresponding vehicle is greater than a threshold; and
control one or more physical vehicles linked to the one or more virtual vehicles in response to receiving inputs on the one or more virtual vehicles.

11. The system according to claim 1, further comprising:
a screen,
wherein the controller is further programmed to:
obtain views of the plurality of physical vehicles captured by cameras of the plurality of physical vehicles; and
display, on the screen, virtual views linked to the views of one or more physical vehicles upon initiation of the teleoperations on the one or more virtual vehicles.

12. The system according to claim 1, further comprising:
a screen,
wherein the controller is further programmed to:
obtain views of the plurality of physical vehicles captured by cameras of the plurality of physical vehicles;
display, on the screen, virtual views linked to the views of the plurality of physical vehicles; and
emphasize, on the screen, one or more virtual views upon initiation of the teleoperations on the one or more virtual vehicles.

13. The system according to claim 1, wherein the driving value for each of the plurality of virtual vehicles comprises a speed, an acceleration, an orientation, or a yaw rate of corresponding physical vehicle.

14. A method comprising:
obtaining state information about a plurality of physical vehicles;
generating a plurality of virtual vehicles linked to the plurality of physical vehicles based on the state information about the plurality of physical vehicles;
determining driving values for the plurality of virtual vehicles based on the state information;
initiating teleoperations on one or more virtual vehicles based on the driving values; and
controlling one or more physical vehicles linked to the one or more virtual vehicles in response to receiving inputs on the one or more virtual vehicles.

15. The method according to claim 14, wherein the one or more virtual vehicles is controlled in a photoreal metaverse environment.

16. The method according to claim 14, wherein the teleoperations are initiated on two or more virtual vehicles.

17. The method according to claim 14, further comprising:
link the plurality of virtual vehicles to the plurality of physical vehicles based on the state information of the plurality of physical vehicles through a cloud.

18. The method according to claim 14, further comprising:
compare each of the driving values for the plurality of virtual vehicles to a threshold value; and
initiate teleoperations on the one or more virtual vehicles in response to the driving values for the one or more virtual vehicles being greater than the threshold value.

19. The method according to claim 14, further comprising:
rank the plurality of virtual vehicles based on a rank queue method;
initiate teleoperations on the virtual vehicle having a first rank first and then initiate teleoperations on the virtual vehicle having a second rank, wherein the first rank is higher than the second rank.

20. The method according to claim 14, wherein the driving value for each of the plurality of virtual vehicles comprises an emergent need, an urgent need, or both, of the teleoperations.
